(19) United States
(12) Patent Application Publication
(10) Pub. No.: US 2011/0260447 A1
(43) Pub. Date: Oct. 27, 2011

(54) Seal, Tank Comprising Such a Seal and Use of Such a Seal

(75) Inventor: Ludovic Duval-Arnould, Saint-Fort (FR)

(73) Assignee: Le Joint Francais

(21) Appl. No.: 13/075,684

(22) Filed: Mar. 30, 2011

(30) Foreign Application Priority Data
Apr. 26, 2010 (FR) 1001788

(51) Int. Cl. F16L 5/02; B65D 90/02

(52) U.S. Cl. 285/220; 220/676; 277/606

(57) ABSTRACT

The subject of the present invention is a ring seal preventing the seal from sliding and/or tilting when tightened.

For this purpose, the invention proposes a seal (10) having an axis of revolution (R) and a median transverse axis (T), and comprising, in cross section, a general D shape defined by a wall (11) forming the back of the D, a wall (12) forming the belly of the D, and two side walls (13).

The seal has a height (H) and a thickness (E), the ratio (E/H) of the thickness (E) over the height (H) being between 0.7 and 0.85, preferably 0.8.

The back wall (11) comprises, in the uncompressed state, a concave face defining a hollow (11a) between two crowns (14), the hollow having a height (h) of between 50% and 60% of the height (H) of the seal, and a depth (p) of between 4% and 8% of the thickness (E) of the seal.

### FIELD OF THE INVENTION

The present invention relates to a non-tilting ring seal, to a tank furnished with such a seal and to a use of such a seal.

### BACKGROUND

For example, the motor industry has to tackle several technical problems involving seals.

A first problem is posed by the introduction of new environmental standards which impose a sharp reduction in the rate of leakage, for example in fluid circuits, in tanks, etc. Certain applications are particularly involved because the measured leakage is essentially due to the permeability of the seal. The applications involved are, for example, the fuel circuit (sealing of the tank, of the connections, etc.), the urea circuit, the air conditioning or any other application in which the fluid can be in a gaseous phase. Certain applications are more critical due to the dimension of the connectors, such as the tank seals or the tank filler pipe seals.

Usually, the tank comprises a tank body having a neck having an axis, the neck being extended by a tubular region, with a smaller section than that of the neck and forming a bung, an annular flange supporting the fuel pump and the gauge, and a nut screwed onto the neck of the tank in order to retain the flange.

An upper face of the neck, a lower face of the plate, an outer cylindrical face of the bung and an inner cylindrical face of the nut define an annular groove for a seal in axial tightening, that is to say parallel to the axis of revolution R. Usually, the tank is made of plastic.

In the context of improving the sealing of vehicles, several manufacturers have turned to the use of O-rings as bung seals.

Usually, the O-ring used has a circular section. This type of seal is easy to manufacture and very cheap.

However, the use of such seals leads to two types of problems, in particular in the case of tanks having a tank body made of plastic, for example of polyethylene:

a) the tolerances of the plastic parts lead to seals having a diameter at least equal to approximately 5 mm, and this results in a problem of space requirement for the groove of the seal, and of deformation of the neck of the tank;

b) there is a problem in keeping the seal on the rim of the tank before the bung is installed.

Certain vehicles are fitted with bung seals which have deformable lips which perform a function of taking up clearance when they are deformed. However, such lip seals are complex in terms of manufacture and use, which causes costs that are difficult to make compatible with the prices practised in this field.

In order to remedy the drawbacks of the circular-section O-ring, document EP 0 811 519 has already proposed manufacturing seals with what is called a “D” profile.

This ring seal has in section an elongated profile parallel to the axis of revolution of the seal. More particularly, the seal comprises, in cross section, a general D shape defined by a flat wall forming the back of the D, a convex wall facing it forming the belly of the D and two side walls connecting the back wall and the belly wall.

There are two advantages to this seal. It makes it possible to reduce the quantity of material compared with a circular-section O-ring and, on the other hand, the flat wall of the back of the D prevents the seal from coming out during installation thereof due to a “roll-back” phenomenon.

It has appeared in practice that, during the tightening and the resulting compression of the “D” seal, the latter makes, in approximately 25% of cases, a more or less pronounced tilt in the annular groove. This tilt is measurable by measuring the angle made between the flat wall of the back of the seal and the outer cylindrical face of the bung. In practice, the tightening comprises an essentially axial component, that is to say substantially parallel to the axis of revolution R. Because of the dimensional tolerances that are sometimes considerable, the tightening may also comprise a significant radial component. In other words, when the two portions of the connector are brought together axially, they can offset each other radially, that is to say substantially parallel to the transverse axis T.

Moreover, during the tightening phase, the seal also sustains a significant radial component because, with the nut being screwed onto the neck, it exerts a shearing force on the seal, parallel to the transverse axis. The result of the compression and of the shearing can cause the D seal to tilt in the groove so that the flat portion is facing the flange, thus reducing the pressure on the seal and consequently the sealing of the assembly.

This tilting may take two forms: sliding by shearing and sliding by rotation. In extreme cases, the sliding by rotation is so great that the seal tilts completely after a rotation of 90°. These sliding actions may lead to a leakage of fluid from the tank.

Many parts of these circuits are made of plastic and notably the parts designed to receive the seals. It is therefore not possible to improve the sealing of these circuits by increasing the compression of the seals without risking deforming these plastic parts or damaging them. The consequence of this compression would be a loss of seal, that is to say an increase in permeability.

### SUMMARY OF THE INVENTION

The subject of the present invention is a seal and a tank making it possible to improve the sealing action by preventing, in virtually all cases, a sliding and/or a tilting of the seal, however minor, during tightening.

For this purpose, the invention proposes a seal allowing a guided creep of a portion of the material of the seal when the latter is compressed.

More precisely, the subject of the present invention is a ring seal made of elastically deformable material, having an axis of revolution and a median transverse axis, and comprising, in cross section, a general D shape defined by a wall forming the back of the D, a wall facing it forming the belly of the D, and two side walls connecting the back wall and the belly wall, in which:
the seal has a height, between the side walls and in projection on the axis of revolution, and a thickness between the back wall and belly wall, in projection on the transverse axis, the ratio of the thickness over the height being between 0.7 and 0.85, preferably 0.8;
the back wall comprises, in the uncompressed state, a concave face defining a hollow between two crowns, the hollow having a height of between 50% and 60% of the height of the seal, and a depth of between 4% and 8% of the thickness of the seal.

The use of such a seal allows an optimal positioning of the seal and prevents it from tilting during tightening, thus improving the sealing action. This stability is obtained by “guiding” the deformation of the seal under the compression effect.

The use of such a seal also makes it possible to save material compared with a conventional D seal, resulting in a lower cost.

According to preferred embodiments:
each side wall may comprise, in the uncompressed state, a face that is flat and substantially parallel to the transverse axis, having a width of between 18% and 35% of the thickness of the seal;
the two crowns connecting the hollow to the flat faces may consist of rounded edges each having a radius of curvature of between 20% and 25% of the height of the seal;
the belly wall may have at least one radius of curvature;
the concave face may have at least one radius of curvature; and/or
the belly wall may be connected to the flat side walls by a flush join or by a radiated join.

The invention also relates to a tank comprising a tank body having a neck having an axis of revolution, the neck being extended by a tubular region with a smaller section than that of the neck, a plate and a nut designed to be screwed onto the neck of the tank, an upper face of the neck, a lower face of the plate, an outer cylindrical face of the tubular region and an inner cylindrical face of the nut defining an annular groove for a seal, and a seal according to the invention.

The invention also relates to a use in a fuel tank comprising a tank body having a neck having an axis, the neck being extended by a tubular region, with a section smaller than that of the neck, a plate, and a nut screwed onto the neck of the tank, an upper face of the neck, a lower face of the plate, an outer cylindrical face of the tubular region and an inner cylindrical face of the nut defining an annular groove for a seal, of an aforementioned seal according to the invention such that:
the wall forming the back of the D is supported by the inner face of the seal, the latter being in contact with the outer cylindrical face of the tubular region; and
the two flat side walls connecting the back wall and the belly wall are in contact with, respectively, the upper face of the neck and the lower face of the plate.

Preferably, the wall forming the belly of the D is placed in the groove, at a distance from the inner cylindrical face of the nut.

### BRIEF DESCRIPTION OF THE DRAWINGS

Other features of the invention will emerge from the following detailed description made with reference to the appended drawings which represent, respectively:

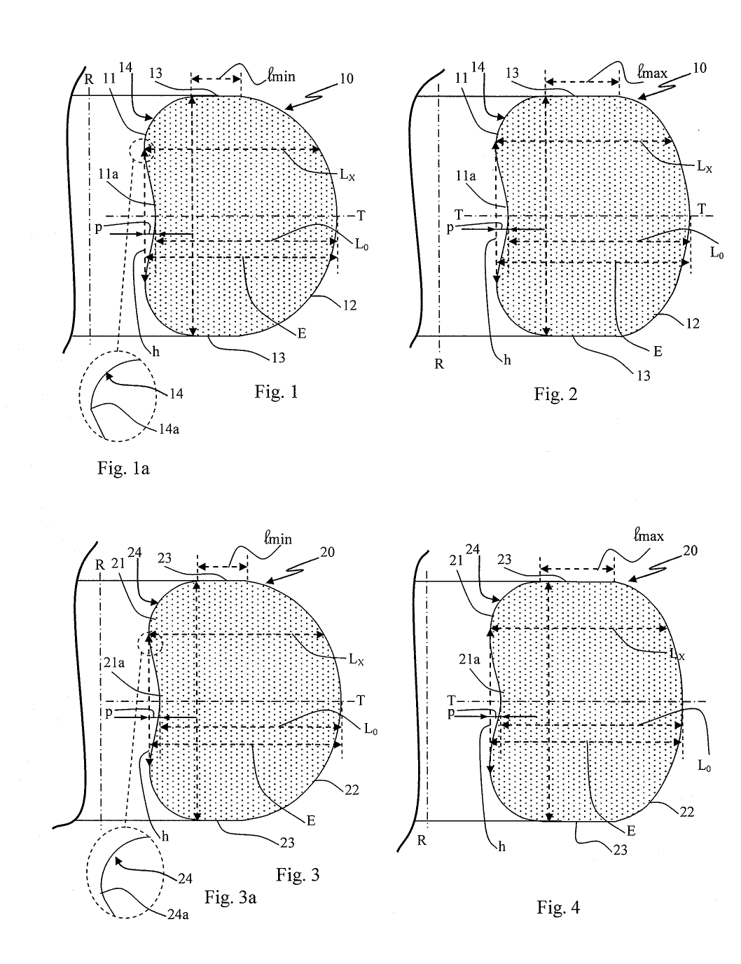

in FIGS. 1 and 2, schematic views of a partial cross section of a first embodiment of a seal according to the present invention;

in FIG. 1a, a schematic view of a partial enlargement of the seal of FIG. 1;

in FIGS. 3 and 4, schematic views of a partial cross section of a second embodiment of a seal according to the present invention;

in FIG. 3a, a schematic view of a partial enlargement of the seal of FIG. 3;

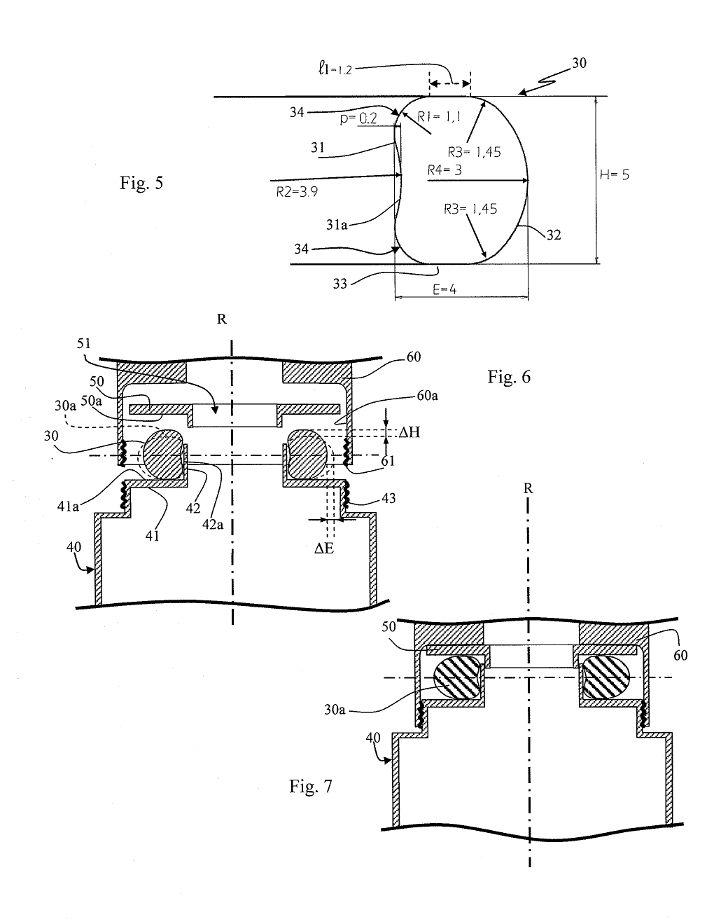

in FIG. 5, a schematic view in cross section of an exemplary embodiment of a seal according to the invention;

in FIG. 6, a schematic view in cross section of a seal according to the invention being mounted in a fuel tank;

in FIG. 7, a schematic view in cross section of a seal according to the invention after mounting and compression in a fuel tank;

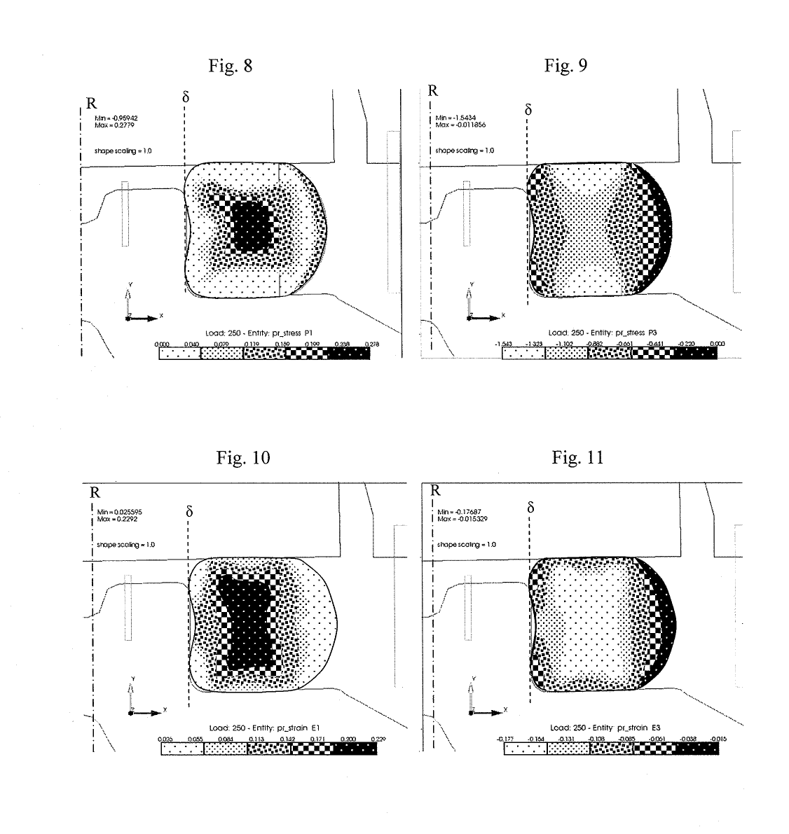

in FIG. 8, a schematic view of a partial cross section of FIG. 7, illustrating the main tensile stresses sustained by the seal;

in FIG. 9, a schematic view of a partial cross section of FIG. 7, illustrating the main compression stresses sustained by the seal;

in FIG. 10, a schematic view of a partial cross section of FIG. 7, illustrating the tensile deformation sustained by the seal; and

in FIG. 11, a schematic view of a partial cross section of FIG. 7, illustrating the deformation in compression sustained by the seal.

### DETAILED DESCRIPTION

In the following description, the following terms will be defined as follows:
Ring seal: a seal having the shape of a solid of revolution, the revolution being able to be elliptical, circular, polygonal, etc., about an axis of revolution situated at the centre of the seal;
Axis of revolution (R)=axis of revolution of the seal;
Median transverse axis (T)=axis perpendicular to the axis of revolution and passing through the middle of the seal. It therefore divides the seal into two portions of equal height;
Cross section=section passing through a transverse axis and the axis of revolution;
A “nominal” dimension (thickness, width, height, depth, radius, etc.): the dimension (thickness, width, height, depth, radius, etc.) at rest when the seal is not compressed.
The thickness of the seal is equal to the largest dimension of the seal in projection on the transverse axis T.
A width of the seal is equal to the distance, parallel to the transverse axis T, between a point on the back wall and a point on the belly wall of the seal.
Compression zone: the zone of the seal that is capable of being compressed under the effect of a stress. This compression may culminate in a movement, or “creep” of the compression zone; by opposition, a flexing zone is capable of flexing under the effect of a stress without being compressed beforehand. Therefore, within the meaning of the present invention, a flexible lip and a compressible zone should not be confused.

The seal described below is made of an elastically deformable material. Preferably, the material of the seal may be chosen from the polymers, in particular from FPM (fluorocarbon rubber), HNBR (hydrogenated nitrile butadiene rubber), AEM (ethylene and methyl acrylate copolymer), ACM (ethyl acrylate (or other acrylate) copolymer and a copolymer providing reactive sites for curing), NBR (nitrile rubber) and EPDM (ethylene, propylene or diene terpolymer).

A first embodiment of a seal 10 according to the invention is illustrated in FIG. 1. The seal 10 has an axis of revolution R and a transverse axis T.

The seal comprises, in cross section, a general D shape. This shape is defined by a wall 11 forming the back of the D, a wall 12 facing it forming the belly of the D and two side walls 13 connecting the back wall 11 and the belly wall 12.

In the embodiment illustrated, the wall 11 forming the back of the D is the inner wall of the seal, that is to say the wall closest to the axis of revolution R. The wall forming the belly of the D is the outer wall of the seal, that is to say the wall furthest away from the axis of revolution R.

According to the invention, the general D shape is defined by the ratio between the nominal height H of the seal and its nominal thickness E.

The height H of the seal is the dimension of the seal between the side walls 13 in projection on the axis of revolution R. The thickness E is the dimension of the seal between the back wall 11 and belly wall 12 in projection on the transverse axis T.

The D shape according to the invention is defined by a ratio E over H of between 0.7 and 0.85, and preferably equal to 0.8. This ratio is given by nominal values of the thickness and of the height of the seal, that is to say when the seal is not compressed.

A ratio E/H of less than 0.7 gives a “bean” shape. Such a seal tilts almost systematically in the groove when there is an axial tightening parallel to the axis of revolution R. Such bean-shaped seals are used only for radial tightening, perpendicular to the axis of revolution R.

A ratio E/H of more than 0.85 is expensive to manufacture since it requires more material. Moreover, it does not make it possible to eliminate the tilting phenomena and requires a considerable tightening force incompatible with plastic parts.

According to another feature of the invention, the back wall 11 of the seal comprises a concave face defining a hollow 11a between two crowns 14. In the uncompressed state of the seal, the hollow has a height h of between 50% and 60% of the nominal height H of the seal. Moreover, the hollow has a depth p of between 4% and 8% of the nominal thickness E of the seal.

The wall 11 forming the back of the D comprises two crowns connecting the hollow 11a to the flat faces 13.

Preferably, these two crowns 14 consist of rounded edges each having a radius of curvature of between 20% and 25% of the height H of the seal. Therefore, for a seal with a height equal to 5 mm, the radius of curvature of each of the crowns 14 is between 1 mm (20% of the height H of the seal) and 1.25 mm (25% of the height H of the seal).

It is well understood that, because of the height h and the depth p of the hollow, the crowns of the seal placed on either side of the hollow do not flex during axial tightening, and therefore do not constitute lips. Because of this, manufacture remains cheap and can be carried out with a two-part mould.

As shown in FIG. 1a, the join between the hollow and a crown may be a flush join 14a, by opposition to a radiated join 24a illustrated in FIG. 3a. In the first case of a flush join, illustrated in FIGS. 1 and 2, the join between the surface of the hollow and the convex surface of the crown 14 constitutes an angular point. On the other hand, in the case of a radiated join, illustrated in FIGS. 3 and 4, the surface of the hollow 21a joins the surface of the crown 24 not via an angular point but via an arc of a circle 24a (see FIG. 3a).

Surprisingly, the presence of the hollow markedly limits the percentage of seals that have tilted after tightening. The presence of the hollow and its depth p allows the material forming the seal, during compression, to creep in a manner directed towards the belly of the D without the seal tilting.

Advantageously, each side wall 13 of the seal comprises a flat face parallel to the transverse axis T and connecting the crowns of the wall 11 forming the back of the D to the wall 12 forming the belly of the D. These flat faces each have, according to the invention, a nominal width l of between 18% and 35% of the nominal thickness E of the seal. FIGS. 1 and 3 illustrate a seal of which the width lₘᵢₙ is 18% of the thickness E of the seal and FIGS. 2 and 4 represent a seal of which the width lₘₐₓ is 35% of the thickness E of the seal.

The flat surfaces are designed to come into contact on the one hand with the upper face 41a of the neck 41 (see FIGS. 6 and 7) and the lower face 50a of the plate 50.

By virtue of the dimensions of these flat surfaces combined with the presence of the hollow 11a on the wall 11 forming the back of the D, virtually no tilting of the seal according to the invention is observed during tightening.

The seal according to the invention advantageously has a nominal width L₀ along the median transverse axis T that is greater than any nominal width Lₓ of the seal, parallel to the median transverse axis T. In other words, the point on the back wall and the point on the belly wall that are furthest from one another, parallel to the transverse axis, are precisely on the median transverse axis T of the seal. Therefore, the maximum nominal width of the seal is situated on the transverse axis T of the seal according to the invention.

This arrangement makes it possible to produce a seal that does not tilt during tightening and that is very easy to manufacture, even with a two-part mould. It is therefore much cheaper than lip seals while being much more effective than the conventional D seals (with flat back) and circular-section O-rings.

FIG. 5 illustrates an exemplary embodiment of a seal according to the invention. This seal 30 has a height H of 5 mm and a thickness E of 4 mm. The seal 30 has a surface 31, forming the back of the D, consisting of a crown 34, a hollow 31a and a second crown 34. The hollow 31a has a depth p equal to 0.2 mm, or 5% of the thickness E.

Each crown 34 consists of an arc of a circle of radius R1 equal to 1.1 mm. This value represents 22% of the height H of the seal. The height h of the hollow is therefore equal to 2.8 mm, that is to say the height H of the seal (5 mm) minus twice the radius R1 (2*1.1=2.2). This height h represents 56% of the height H of the seal.

The hollow 31a is generated in the example of FIG. 5 by a curve consisting of a single arc of a circle. Alternatively, the hollow can be generated by a curve consisting of several arcs of a circle. In the example illustrated, and when the curve is generated by a single arc of a circle, the nominal value of the radius of the arc of a circle is advantageously equal to the height H of the seal minus the radius R1 of a crown. In FIG. 5, the radius R2 is therefore equal to 5-1.1 mm, namely 3.9 mm. The centre of the arc of a circle of radius R2 is situated on the median transverse axis T.

The flat side walls 33 have a width l₁ equal to 1.2 mm. This width represents 30% of the thickness E.

The wall 32 forming the belly of the D consists, in the example of FIG. 5, of three arcs of a circle joined to one another. More particularly, the wall 32 comprises two arcs of a circle of radius R3 equal to 1.45 mm joined to an arc of a circle of radius R4 equal to 3 mm.

Alternatively, the wall 32 could be formed by only one arc of a circle.

As with the join between the hollow with the crowns, the wall 32 can be joined to the flat side walls 33 by a flush join or by a radiating join. The use of a flush join makes it possible to increase the width of the flat side walls while maintaining the thickness and the width of the seal.

FIGS. 6 and 7 illustrate the use of a seal according to the invention in axial tightening (that is to say parallel to the axis of revolution R) in a fuel tank.

The tank comprises a tank body 40 having a neck 41 with an axis of revolution R and extended by a tubular region 42, with a smaller section than that of the neck. The tubular region 42 is arranged relative to the neck in order to have the same axis of revolution R. The tank also comprises a plate 50 designed to support the fuel pump and the gauge. The plate 50 has a passageway 51 for the fuel. Finally, the tank comprises a nut 60 designed to be screwed onto the neck 41 of the tank 40. As illustrated in FIGS. 6 and 7, this screwing is obtained by interaction of a thread 61 supported by the tank and a tapping 41 supported by the nut 60.

According to the invention, a seal as characterized above is used in this tank.

In particular, this use is made such that:
the wall 31 forming the back of the D is supported by the inner face of the seal, the latter being in contact with the outer cylindrical face 42a of the tubular region 42; and
the two flat side walls 33 connecting the back wall 31 and the belly wall 32 are in contact with, respectively, the upper face 41a of the neck 41 and the lower face 50a of the plate 50.

Advantageously, the tank is dimensioned so that the wall forming the belly of the D is placed in the groove, at a distance from the inner cylindrical face of the nut.

FIG. 6 shows the tank during assembly. In this position, the seal 30 has its nominal dimensions. It is placed in a groove consisting of an upper face 41a of the neck 41, a lower face 50a of the plate 50, an outer cylindrical face 42a of the tubular region 42 and an inner cylindrical face 60a of the nut 60. “Outer” means that the face is turned away from the axis of revolution R while “inner” means that the face is turned towards the axis of revolution R.

FIG. 7 shows the seal compressed, once the plate 50a has been tightened against the neck and held in this position by the nut 60. In FIG. 6, the compressed shape 30a of the seal as illustrated in FIG. 7 has been shown in dash-dotted lines. Thus, between the nominal position 30 in which the seal is not compressed, and the position of use 30a, in which the seal is compressed, there is a height variation AH and a thickness variation ΔE. Therefore, after having been compressed, the seal has a height H that is smaller than the nominal height H and a thickness E that is greater than the nominal thickness E.

FIGS. 8 to 11 illustrate the stresses and deformations sustained by the seal during tightening. In general, it can be seen that, by virtue of the shape of the seal according to the invention, the axial tightening causes no tilting of the seal. In other words, the straight line δ passing through the crowns of the wall forming the back of the D is perfectly parallel to the axis of revolution R. In most cases, the crowns of the wall forming the back of the D remain in contact with the outer cylindrical face 42a of the tubular region of the tank. It may happen that the crowns separate from the outer cylindrical face 42a. Nevertheless, even in this case, the straight line δ passing through the crowns of the wall forming the back of the D remains substantially parallel to the axis of revolution R, by virtue of the shape in section of the seal according to invention.

FIG. 8 shows that the core of the seal sustains a very high tensile stress, in other words a unit volume of material situated at the core of the seal is much more stretched than the same unit volume of material situated close to one of the flat side walls.

This figure also shows that the portion constituting the wall forming the belly of the D also sustains localized stretching which is explained by the thickness variation ΔE during the axial tightening.

FIG. 9 illustrates the main compression stresses sustained by the seal. This figure shows that the portion of the material situated beneath the wall forming the belly of the D is stretched (in this figure, it is a negative compression) since the shape of the seal according to the invention allows, during the axial tightening, a guided deformation of the seal, perpendicularly to the axis of revolution R, and towards the wall of the belly of the D.

FIGS. 10 and 11 illustrate the percentage of deformation of the seal, respectively in tension (FIG. 10) and in compression (FIG. 11). These figures illustrate the deformation sustained by a unit volume, in percentage, between the initial state in which the seal is not compressed and the final state in which the seal is compressed.

In particular, FIGS. 10 and 11 show that the deformation is mainly localized at the belly of the D. Thus, by virtue of the shape of the seal according to the invention, it is the belly of the D which “absorbs” all the deformation in a guided localized manner, and allows the rest of the seal to remain in an optimal position, that is to say with no tilting and against their respective bearing surface.

1. A ring seal made of elastically deformable material, having an axis of revolution (R) and a median transverse axis (T), and comprising, in cross section, a general D shape defined by a wall forming the back of the D, a wall facing it forming the belly of the D, and two side walls connecting the back wall and the belly wall, wherein:
the seal has a height (H), between the side walls and in projection on the axis of revolution (R), and a thickness (E) between the back wall and belly wall, in projection on the transverse axis (T), the ratio (E/H) of the thickness (E) over the height (H) being between 0.7 and 0.85,
the back wall comprises, in the uncompressed state, a concave face defining a hollow between two crowns, the hollow having a height (h) of between 50% and 60% of the height (H) of the seal, and a depth (p) of between 4% and 8% of the thickness (E) of the seal.

2. The ring seal according to claim 1, in which each side wall comprises, in the uncompressed state, a face that is flat and substantially parallel to the transverse axis (T), having a width (l, l₁, lₘᵢₙ, lₘₐₓ) of between 18% and 35% of the thickness (E) of the seal.

3. The ring seal according to claim 1, in which the two crowns connecting the hollow to the flat faces consist of rounded edges each having a radius of curvature of between 20% and 25% of the height (H) of the seal.

4. The ring seal according to claim 1, in which the belly wall has at least one radius of curvature.

5. The ring seal according claim 1, in which the concave face has at least one radius of curvature.

6. The ring seal according to claim 2, in which the belly wall is connected to the flat side walls by a flush join.

7. The ring seal according to claim 2, in which the belly wall is connected to the flat side walls by a radiated join.

8. A tank comprising a tank body having a neck having an axis of revolution (R), the neck being extended by a tubular region with a smaller section than that of the neck, a plate and a nut designed to be screwed onto the neck of the tank, an upper face of the neck, a lower face of the plate, an outer cylindrical face of the tubular region and an inner cylindrical face of the nut defining an annular groove for a seal, and a seal according to claim 1.

9. Use in a fuel tank comprising a tank body having a neck having an axis, the neck being extended by a tubular region, with a section smaller than that of the neck, a plate, and a nut screwed onto the neck of the tank, an upper face of the neck, a lower face of the plate, an outer cylindrical face of the tubular region and an inner cylindrical face of the nut defining an annular groove for a seal, of a seal according to claim 1, so that:
the wall forming the back of the D is supported by the inner face of the seal, the latter being in contact with the outer cylindrical face of the tubular region; and
the two flat side walls connecting the back wall the belly wall are in contact with, respectively, the upper face of the neck and the lower face of the plate.

10. Use according to claim 9, in which the wall forming the belly of the D is placed in the groove, at a distance from the inner cylindrical face of the nut.
